(19) United States
(12) Patent Application Publication
(10) Pub. No.: US 2004/0267977 A1
(43) Pub. Date: Dec. 30, 2004

(54) Topology based replacement routing of signal paths

(76) Inventor: Mysore Sriram, San Jose, CA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/610,855

(22) Filed: Jun. 30, 2003

(51) Int. Cl. G06F 17/50

(52) U.S. Cl. 710/10; 716/13

(57) ABSTRACT

A replacement path is identified for a signal path of a circuit design from if possible, topological equivalent alternate paths of the signal path, and if not possible, from topologically morphed versions of the signal path. In various embodiments, topological equivalent alternate paths are identified by sliding one or more path segments of (the topologically morphed version of the) the signal path. In various embodiments, topology morphing may be effectuated through breaking of one or more path segments, each at one or more points.

### FIELD OF THE INVENTION

Embodiments of the present invention relate to the fields of integrated circuits and electronic design automation. More specifically, embodiments of the present invention are related to a signal routing technique that identifies if possible, a replacement path for a signal path of an integrated circuit design, based at least in part on the topology of the signal path.

### BACKGROUND OF THE INVENTION

As integrated circuit technology continues to advance, modern integrated circuits (IC) have become very complex, and difficult to design. Resultantly, various electronic design automation (EDA) tools have been developed to assist in the design of integrated circuits (IC). In particular, physical planning tools, having signal routing capabilities have been developed to assist IC designers in planning the physical layout of an IC including signal paths.

As those skilled in the art would appreciate, signal routing is relatively difficult as it often requires having a large set of design objectives, timing requirements, and so forth to be met concurrently. Accordingly, as a complex IC design, such as a microprocessor, evolves from one version to the next, it is often desirable to keep the subset of “critical” signal paths stable, i.e. undisturbed or unchanged, if possible.

However, as function block changes, e.g. due to a function block growth resulted from increase in functionalities, or routing space shrinkage, e.g. due to shrinkage of a design, it may not be always possible to keep the entire subset of “critical” signal paths stable.

In that case, it would be desirable to at least keep the changes or disturbances to the subset of “critical” signal paths as minimal as possible.

One approach that has been attempted in the prior art is to employ what is referred to as tunneling, an example of which is illustrated in FIG. 9. As shown, under the tunneling approach, a “tunnel”, such as example tunnel 904, is specified to constrain the re-routing of a signal path, such as signal path 902. For the example, re-rerouting of signal path 902 is necessitated by the “growth” of function blocks 906a-906c. However, it is not uncommon for many prior art physical planning tools to offer signal path 908, having numerous turns moving around function blocks 906a-906c as a recommended replacement signal path, when in fact, signal path 910 is most likely a “better” replacement signal path.

Thus, an improved replacement signal routing technique is desired.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates a system view of the present invention, in accordance with one embodiment;

FIG. 2 illustrates the concept of topologically equivalent signal path, including their creations through path segment sliding, and their usage to re-route a signal path;

FIG. 3 illustrates the concept of topology morphing, including path segment breaking, and their usage to re-route a signal path;

FIG. 4 illustrates an overview of the replacement routing method of the present invention, in accordance with one embodiment;

FIG. 5 illustrates a method for identifying a replacement path from topologically equivalent alternate paths of a single path of circuit design, in accordance with one embodiment;

FIGS. 6a-6b illustrate enumeration of topologically equivalent alternate paths of a signal path of a circuit design, in accordance with one embodiment;

FIG. 7 illustrates a method for identifying a replacement path from topologically morphed alternate paths of a signal path of a circuit design, in accordance with one embodiment;

FIG. 8 illustrates an example computer system suitable for practicing the present invention, in accordance with one embodiment; and

FIG. 9 illustrates a prior art signal routing technique, employing “tunnels”.

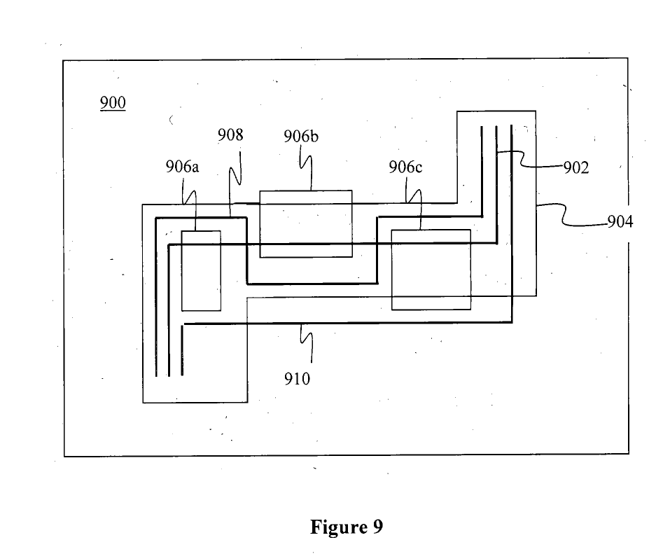

### DETAILED DESCRIPTION OF EMBODIMENTS OF THE INVENTION

Embodiments of the present invention include but are not limited to a signal router, EDA software having such signal router, and apparatuses endowed with such signal router.

Parts of the description will be presented in terms commonly employed by those skilled in the art to convey the substance of their work to others skilled in the art, such as signal paths, path segments, and so forth. These terms are to be accordingly their common meaning as understood by those skilled in the art.

In the following description, various aspects of different embodiments of the present invention will be described. However, it will be apparent to those skilled in the art that other embodiments may be practiced with only some or all described aspects. For purposes of explanation, specific numbers, materials and configurations are set forth in order to provide a thorough understanding of the present invention. However, it will be apparent to one skilled in the art that other embodiments may be practiced without the specific details. In other instances, well-known features are omitted or simplified in order not to obscure the embodiments being described.

Various operations will be described as multiple discrete operations in turn, in a manner that is most helpful in understanding these embodiments, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

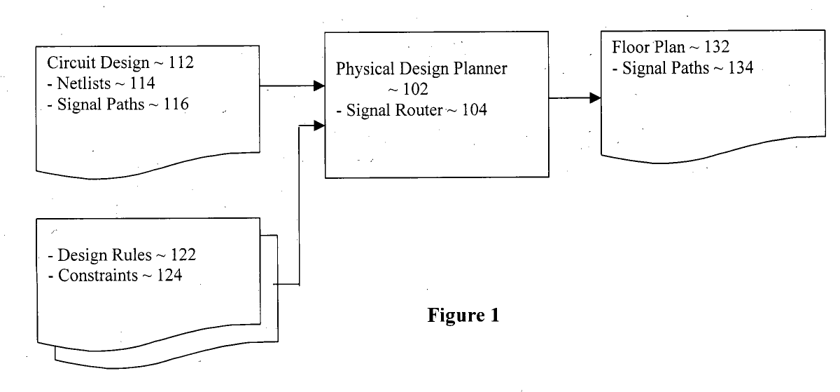

Refer now to FIG. 1, wherein an overview of the present invention, in accordance with one embodiment, is shown. As illustrated, for the embodiment, the present invention includes signal router 104, equipped to identify if possible, a replacement path for a signal path for a circuit design, which for the embodiment is an IC. More specifically, signal router 104 is advantageously equipped to identify a replacement path, based on topologically equivalent or slightly morphed (topologically speaking) alternate paths. Resultantly, often times, the replacement path identified is more desirable, closer to the original signal path, and the identification is accomplished more efficiently.

For the embodiment, signal router 104 is part of physical design planner 102. Other embodiments may be practiced with signal router 104 being a standalone unit or integrated with other tools, beside a physical planning tool.

As illustrated, physical designer planner 102 takes circuit design 112, design rules 122 and planning constraints 124 as inputs. Circuit design 112 includes in particular netlists 114 and signal paths 116, of which, one or more requires re-routing with replacement paths that are preferably close to their original path.

In response, physical designer planner 102, including signal router 104, processes the inputs, and plans the physical locations of the various function blocks and signal paths of circuit design 112 accordingly, resulting in floor plan 132 with signal paths 134.

Circuit design 112, including design rules 122 and constraints 124, may be any circuit designs, any design rules and any constraints. There is no anticipated limitation with respect to any of these entities, with which embodiments of the present invention may be practiced.

Similarly, except for the described teachings, physical designer planner 102, including signal router 104, may be any of one of these elements known in the art or to be designed.

The teachings incorporated with signal router 104 to more effectively and efficiently identify if possible, a replacement path for a signal path of a circuit design will be described in more detail in turn below.

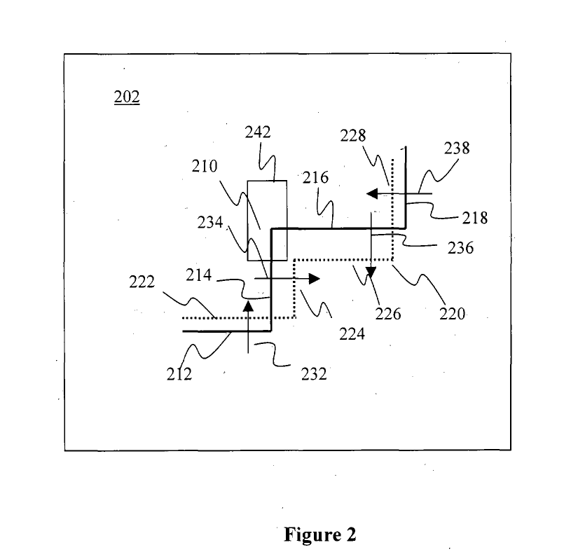

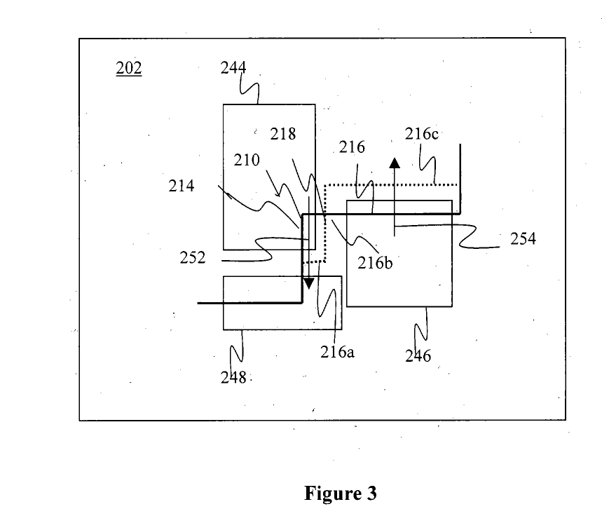

Before doing so, the concepts of topologically equivalent signal paths, and topology morphing, and their applications to signal path re-routing will first be described, with references to FIGS. 2-3.

In particular, FIG. 2 illustrates a signal path 210 of IC 202 and a topologically equivalent signal path 220. The term “signal path” as used herein refers to a signal transmission line having a number of path segments. Each path segment may be considered as having a direction or orientation.

For example, in the case of signal path 210, it comprises signal path segments 212, 214, 216 and 218. Signal path segments 212 and 216 have a “horizontal” direction or orientation, whereas signal path segments 214 and 218 have a “vertical” direction or orientation. The direction/orientation is “relatively”. That is, if viewing of IC 202 is rotated by 90 degrees, signal path segments 212 and 216 may be considered as “vertically” oriented, whereas signal path segments 214 and 218 may be considered as “horizontally” oriented instead.

For the purpose of the application, a signal path is considered to be topologically equivalent to another signal path, if the two signal paths have a 1:1 correspondence for path segments. That is, the two topologically equivalent signal paths necessarily have the same number of path segments, and the corresponding path segments are necessarily parallel to one another (similarly oriented).

For the example illustrated in FIG. 2, signal path 220 also has 4 path segments, path segments 222-228, and path segments 222-228 correspond to path segments 212-218 of signal path 210 respectively Accordingly, signal paths 210 and 220 are considered to be topologically equivalent.

Topologically equivalent signal paths may be formed by sliding the path segments of a signal path in directions orthogonal to their orientations in a coordinated manner. For example, topologically equivalent signal path 220 may be considered as a signal path formed by sliding path segments 212-218 in the directions of 232-238 respectively, i.e. in each case, in a direction orthogonal to the path segment's orientation.

As illustrated, topologically equivalent signal path 220 may be employed as a replacement path for signal path 210 to avoid “obstacle” 242, which may have “grown” from an earlier version of IC 202 when signal path 210 was first established.

As those skilled in the art would appreciate, topologically equivalent signal path 220 closely resembles as well as proximately located adjacent to original signal path 210, thus is likely to meet the same design rules and/or constraints, signal path 210 has to meet.

Since each of path segments 212-218 may be slid for any one of a number of distances in either the directions of 232-238 or in the opposite directions (in a coordinated manner), theoretically, virtually infinite number of topologically equivalent alternate paths may be enumerated for a signal path. However, in practice, since the objective is to identify a replacement path that closely resembles and proximately disposed as the original signal path, depending on the granularity or resolution, only finite numbers of topologically equivalent alternate paths, well within the processing power of common modern computers, need to be enumerated and evaluated.

In the presently preferred embodiments, parameters that affect the scope of the analysis/search, such as the size of each slide, and the number of slides, are configurable. Such configuration may be facilitated via any one of a number of configuration techniques, known in the art or to be designed.

However, due to a number of factors, a proximally located topologically equivalent replacement path may not be available. Under the circumstances, as alluded to earlier, various embodiments will also seek to identify a proximally disposed replacement path that is only slightly morphed, topologically.

While for ease of understanding, only “vertical” and “horizontal” orientations have been illustrated, other embodiments are not so restricted. Other embodiments may be practiced with signal paths having path segments with other “directions”, in particular, “non-orthogonal” directions.

Similarly, for ease of understanding, path segments 212-218 and 222-228 are illustrated as being disposed on the same layer of IC 202. However, other embodiments may also be practiced with one or more pairs of the corresponding path segments being disposed on different layers. For example, for signal paths 210 and 220, one or more pairs of path segments 212 and 222, 214 and 224, 216 and 226, and 218 and 228 may be disposed on different layers.

FIG. 3 illustrates the concept of topology morphing, in accordance with one embodiment. As illustrated, the topology of signal path 210 may be morphed by breaking path segment 216 into two portions 216a and 216c at breakpoint 218, and sliding them away from each other in the directions of 252 and 254. The two portions 216a and 216c are connected through the addition/insertion of bridge portion 216b.

Note that for the illustrated example, sliding by quite substantial distances for both path segments 214 and 216 would have to be made before a topologically equivalent alternate path that clear all three “obstacles” 244-248 may be found.

Thus, for the example, a slight topologically morphed signal path may provide a better alternate path than a topological equivalent alternate path.

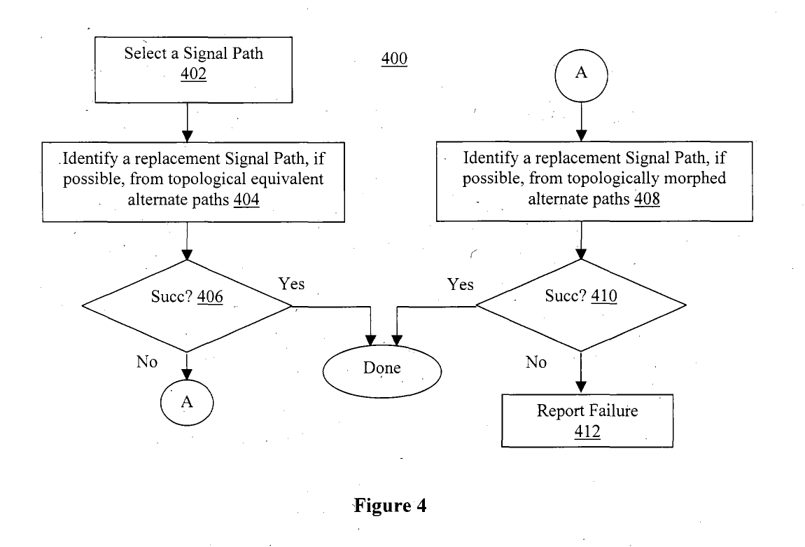

Refer now to FIG. 4, wherein an overview of a method of the present invention for identifying if possible, a replacement path for a signal path of a circuit design, in accordance with one embodiment is illustrated. As illustrated, on selection of a signal path needing a replacement path, block 402, signal router 104 first attempts to identify if possible, a replacement path for the selected signal path, from a number of topologically equivalent alternate paths, block 404, to be described more fully below.

If the attempt is successful, i.e. a replacement path was successfully selected from the topologically equivalent alternate paths, block 406, branch “yes”, for the embodiment, the process terminates.

However, if the attempt was unsuccessful, i.e. signal router 104 was not able to identify a replacement path from the topologically equivalent alternate paths, block 406, branch “no”, for the embodiment, the process continues at block 408.

At block 408, signal router 104 attempts to identify if possible, a replacement path, by slightly morphing the topology of the selected signal path, to be described more fully below.

Then, signal router 104 determines at block 410, whether the attempt is successful, i.e. identification of a replacement path by topology morphing.

If the attempt is successful, i.e. a replacement path was successfully identified through topology morphing, block 410, branch “yes”, for the embodiment, the process terminates.

However, if the attempt was unsuccessful, i.e. signal router 104 was not able to identify a replacement path by morphing its topology, block 410, branch “no”, for the embodiment, signal router 104 reports the “failure”, and terminates the process.

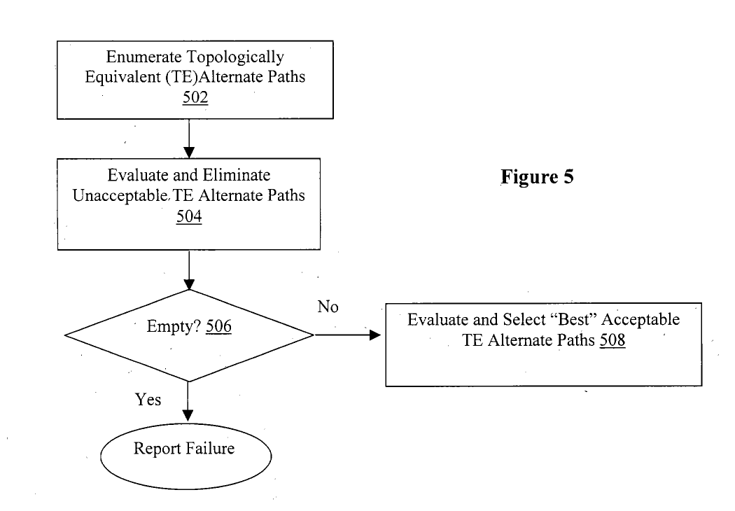

Refer now to FIG. 5, wherein a method for identifying a replacement path for a signal path of a circuit design, from a number of topologically equivalent alternate paths, in accordance with one embodiment, is illustrated.

As illustrated, signal router 104 first enumerates a number of topologically equivalent alternate paths for consideration, block 502. Recall from earlier description, topological equivalent alternate paths of a signal path may be enumerated by sliding and/or changing the lengths of the path segments of the signal path in a coordinated manner. Recall, also that the number of topological equivalent alternate paths enumerated for analysis is implementation dependent, preferably user configurable.

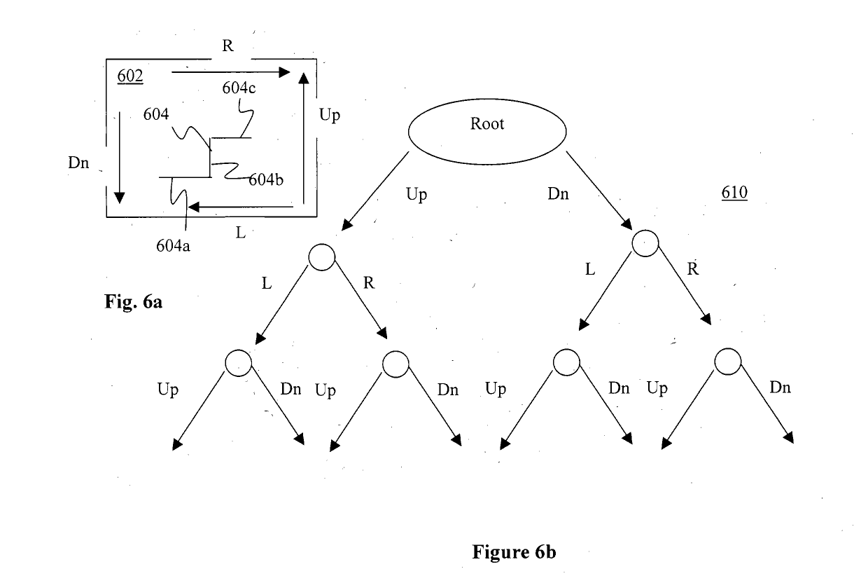

FIGS. 6a-6b illustrate a part of the enumeration process for an example signal path, in accordance with one embodiment. As shown, for the example signal path 604 (with 3 path segments 604a-604c), a set of topologically equivalent alternate paths (illustrated as a “tree” structure 610) may be enumerated in a “depth first” manner.

A first topologically equivalent alternate path is generated by sliding path segments 604a-604c “up”, “left” and “up” by distances d1, d2 and d3 respectively; further path segment 604b is shortened/lengthened by |d1-d3|, depending whether d1 is >d3 or d3 is >d1, and path segments 604a and 604c are shortened and lengthened respectively by d2.

Next, a second topologically equivalent alternate path is generated by sliding path segments 604a-604c “up”, “left” and “down” by distances d1, d2 and d3 respectively; further, path segment 604b is shortened by d1+d3, and path segments 604a and 604c are shortened and lengthened respectively by d2.

For the embodiment, the process continues in this “depth first” manner, and having six more additional topologically equivalent alternate paths generated as shown.

The process is then repeated n more times for different distance values to generate n more sets of topologically equivalent alternate paths. As described earlier, preferably, the distance values, n, as well as other parameters are all user configurable.

Referring now back to FIG. 5, upon enumerating the topologically equivalent alternate paths to be considered, signal router 104 systematically evaluates the topologically equivalent alternate paths for conformance with the design rules, and constraints, eliminating all non-conforming alternate paths from further consideration, block 504. The exact nature of the evaluation is design dependent, known in the art, and non-essential to the practice of the various embodiments of the present invention.

At block 506, signal router 104 determines if the processing returns with an empty set, i.e. no conforming topologically equivalent alternate paths were found. For the embodiment, if the processing returns an empty set, the failure is reported.

However, if the processing returns a non-empty set, i.e. conforming topologically equivalent alternate paths were found, signal router 104 evaluates and selects the “best” conforming topologically equivalent alternate paths, block 508.

For the embodiment, the “best” conforming topologically equivalent alternate path is the conforming topologically equivalent alternate path that is “closest” to the original signal path. More specifically, “closest” is measured at least in terms of the path length, and then distances separating the corresponding vertices (starting and end points of the signal paths).

For the embodiment, the two metrics are equally weighted. However, in alternate embodiments, the metrics may be weighted differently. Further, additional metrics may be employed, as well as other factors may be employed in addition to or in lieu of the “closeness” factor in selecting the “best” topologically equivalent alternate path.

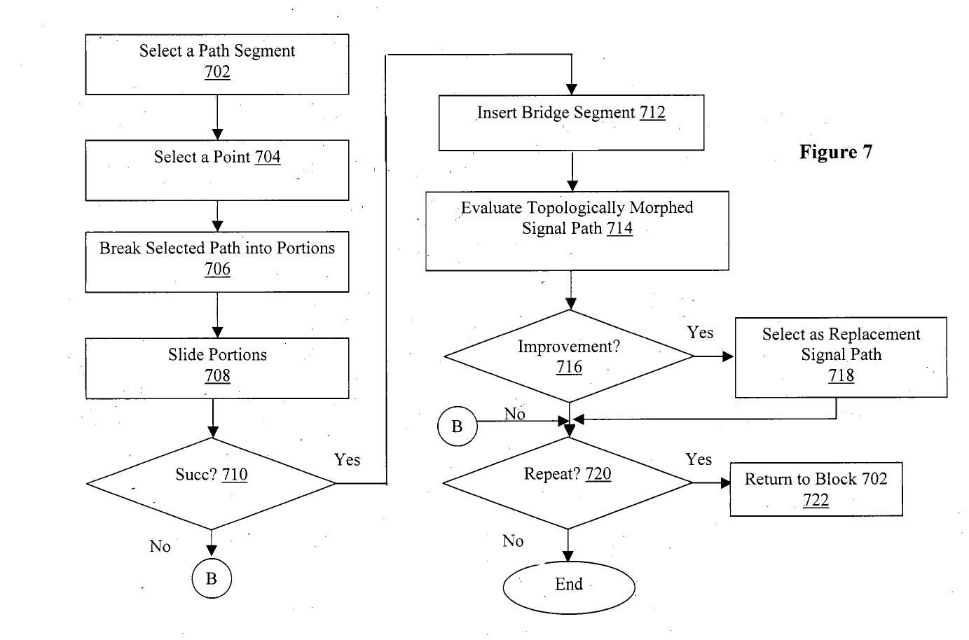

Refer now to FIG. 7, wherein a method for identifying a replacement path for a signal path of a circuit design by slightly morphing the signal path's topology, in accordance with one embodiment, is shown. As illustrated, signal router 104 first selects a path segment to be broken, block 702. In one embodiment, the path segment with the most “difficulty”, e.g. with “difficulty” being defined as having to be slid the most distances to clear-all obstacle is selected. In alternate embodiments, other factors may be employed in addition to or in lieu of the largest sliding distance factor to select the path segment to be broken for topology morphing.

Next, on selection of a path segment, a break point is selected, block 704. For the embodiment, the mid-point of the selected path segment is selected as the break point. In alternate embodiments, the break point may be selected arbitrarily or employing other heuristic factors.

Regardless, because path segments may be slid to enumerate various alternate paths for consideration, the manner the break point is selected is not consequential with respect to its effect on the eventual solution.

Still referring to FIG. 7, upon selection of a break point, signal router 104 breaks the selected path segment into two portions, block 706, and slides the two portions in opposing directions. The sliding is guided by the locations of the obstacles to be avoided.

At block 710, signal router 104 determines whether within the constraint of a configurable maximum sliding distance, new locations unobstructed by any obstacles are found for the broken portions of the selected path segments.

If the new locations were not found, the process continues at block 720, to be described more fully below.

If the new locations were found, signal router 104 insert a bridge path segment reconnecting the two broken portions slid away from each other, block 712.

Upon reconnecting the two slid apart portions, signal router 104 evaluates whether the new alternate path with the morphed topology remains in conformance with the design rules and the constraints, and whether the new signal path with the morphed topology improves over the last alternate path considered, block 714.

If the new alternate path with the morphed topology improves over the last alternate path considered (which by definition is true for the first pass), the new alternate path is selected as the replacement path, block 718.

Then, at block 720, signal router 104 determines whether the process should be repeated. In one embodiment, the decision is made based at least in part on whether all original path segments have been attempted. In another embodiment, the decision is further made based on a number of configurable metrics, e.g. maximum number of passes, incremental improvement less than a threshold, and so forth.

If the process is to be repeated, the process continues back at block 702.

If the process is to be terminated, the last selected alternate path is chosen as the replacement path. If no replacement path is found, the failure is reported.

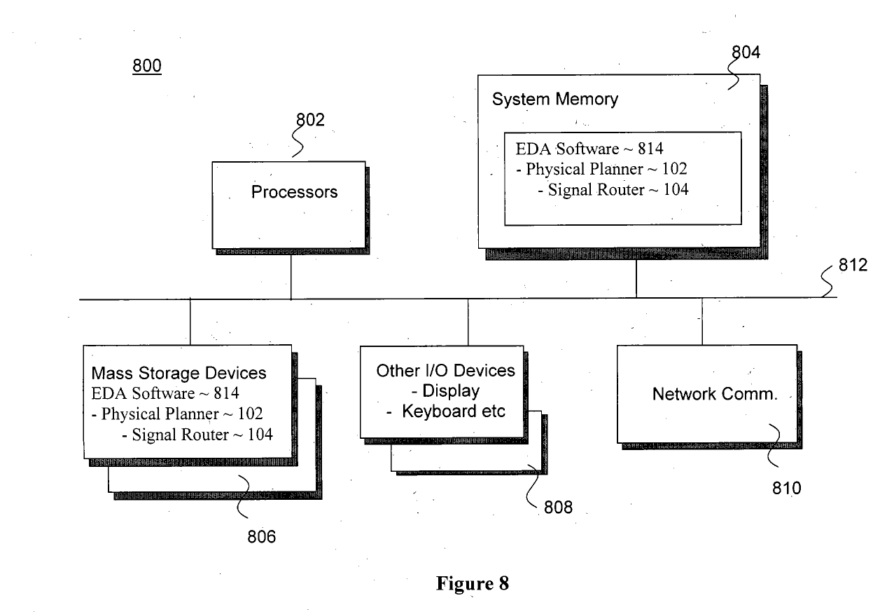

FIG. 8 illustrates an example computing device 800, suitable for use to practice the present invention, in accordance with one embodiment. As illustrated, computing device 800 includes one or more processors 802, system memory 804, mass storage devices 806, other I/O devices 808 and network communication interface 810, coupled to each other via system bus 812 as shown.

Processor 802 is employed to execute various EDA software components 814, e.g. physical planner 102, including signal router 104. Processor 802 may be any one of a number of processors known in the art or to be designed. Examples of suitable processors include but are not limited microprocessors available from Intel Corp of Santa Clara, Calif.

System memory 804 is employed to store working copies of EDA software 814, including physical planner 816 and operating system services. System memory 804 may be Dynamic Random Access Memory (DRAM), Synchronous DRAM (SDRAM) or other memory devices of the like.

Mass storage devices 806 are employed to persistently store data, including e.g. a persistent copy of EDA software 814 including physical planner 102 and signal router 104. Examples of mass storage devices 806 include but are not limited to hard disks, CDROM, DVDROM, and so forth.

Other I/O devices 808 are employed to facilitate other aspects of input/output. Examples of other I/O devices 808 include but are not limited to keypads, cursor control, video display and so forth.

Network communication interface 810 is employed to facilitate network communication with other devices, e.g. a distribution server of EDA software 814 (not shown). Network communication interface 810 may be wired based or wireless. In various embodiments, network communication interface 810 may support any one of a wide range of networking protocols.

In various embodiments, computing device 800 may be a desktop computer, a laptop computer, a tablet computer, a palm-sized computing device, a PDA, and so forth.

### Conclusion and Epilogue

Thus, it can be seen from the above descriptions, a novel technique to more efficiently and effectively identify a replacement path for a signal path of a circuit design has been described.

While embodiments of the present invention have been described in terms of the foregoing embodiments, those skilled in the art will recognize that the invention is not limited to the embodiments described. Other embodiments can be practiced with modification and alteration within the spirit and scope of the appended claims.

For example, while the embodiments have been substantially described in the context of signal paths of circuits of integrated circuit designs, other embodiments may also be practiced to re-route signal paths of circuits of circuit boards, or other electronic components.

Thus, the description is to be regarded as illustrative instead of restrictive.

What is claimed is:

1. A signal routing method comprising:
identifying for a signal path of a circuit design, one or more alternate paths that are topological equivalent to the signal path; and
selecting if possible, a replacement path for the signal path from the one or more topological equivalent alternate paths.

2. The method of claim 1, wherein at least one of said identifying of an alternate path comprises sliding a path segment of the signal path by an offset amount in a direction substantially orthogonal to an orientation of the path segment.

3. The method of claim 2, wherein the path segment is vertically oriented, and said sliding comprises sliding the vertically oriented path segment by the offset amount in a horizontal direction.

4. The method of claim 2, wherein the path segment is horizontally oriented, and said sliding comprises sliding the horizontally oriented path segment by the offset amount in a vertical direction.

5. The method of claim 1, wherein said selecting comprises determining whether each of the identified alternate paths meets a design constraint.

6. The method of claim 1, wherein said selecting comprises comparing proximities of the end points of one or more of the one or more alternate paths to corresponding end points of the signal path.

7. The method of claim 1, wherein the replacement path being one of the one or more alternate paths having end points that overall, are considered to be closest to end points of the signal path.

8. The method of claim 1, wherein the method further comprises
when unable to select a replacement path for the signal path from the one or more topological equivalent alternate paths,
generating a topologically morphed version of the signal path; and
selecting a replacement path for the signal path using the topologically morphed version of the signal path.

9. A signal routing method comprising:
generating a first topologically morphed version of a signal path of a circuit design; and
selecting if possible, a replacement path for the signal path using the first topologically morphed version of the signal path.

10. The signal routing method of claim 9, wherein said generating of the first topologically morphed version of the signal path comprises
selecting a first path segment of the signal path;
selecting a point on the first path segment to break the first path segment into a first and a second portion;
sliding the first and second portions of the first path segment in opposite directions by a first and a second offset amount respectively, the opposite directions being substantially orthogonal to an orientation of the first path segment; and
inserting a bridge portion to connect the first and the second portion of the first path segment.

11. The signal routing method of claim 10, wherein the method further comprises at least one of
adjusting a length of a second path segment preceding the first portion of the first path segment; and
adjusting a length of a third path segment following the second portion of the first path segment.

12. The signal routing method of claim 9, wherein said selecting comprises
identifying for the first topologically morphed version of the signal path, one or more alternate path s that are topological equivalent to the first topologically morphed version of the signal path; and
selecting if possible, a replacement path for the first topologically morphed version of the signal path from the one or more topological equivalent alternate paths.

13. The signal routing method of claim 9, wherein the method further comprises
when unable to select a replacement path for the signal path using the first morphed version of the signal path,
generating a second topologically morphed version of the signal path; and,
selecting if possible, a replacement path for the signal path using the second topologically morphed version of the signal path.

14. The signal routing method of claim 13, wherein generating of the second topologically morphed version of the signal path comprises generating the second topologically morphed version of the signal path based on the signal path.

15. The signal routing method of claim 13, wherein generating of the second topologically morphed version of the signal path comprises generating the second topologically morphed version of the signal path based on the first topologically morphed version signal path.

16. An article of manufacture comprising:
a recordable medium; and
a plurality of machine readable programming instructions recorded on said recordable medium, with the programming instructions designed to enable a computing apparatus to
identify for a signal path of a circuit design, one or more alternate paths that are topological equivalent to the signal path; and
selecting if possible, a replacement path for the signal path from the one or more topological equivalent alternate paths.

17. The article of claim 16, wherein the programming instructions are designed to enable the computing apparatus to perform at least one of said identifying of an alternate path by sliding a path segment of the signal path by an offset amount in a direction substantially orthogonal to an orientation of the path segment.

18. The article of claim 16, wherein the programming instructions are further designed to enable the computing apparatus to generate a topologically morphed version of the signal path, and select a replacement path for the signal path using the topologically morphed version of the signal path, when the computing device is unable to select a replacement path for the signal path from the one or more topological equivalent alternate paths.

19. An article of manufacture comprising:
a recordable medium; and
a plurality of machine readable programming instructions recorded on said recordable medium, with the programming instructions designed to enable a computing apparatus to
generate a first topologically morphed version of a signal path of a circuit design; and
select if possible, a replacement path for the signal path using the first topologically morphed version of the signal path.

20. The article of claim 19, wherein the programming instructions are designed to enable the computing apparatus to perform said generating by
selecting a first path segment of the signal path;
selecting a point on the first path segment to break the first path segment into a first and a second portion;
sliding the first and second portions of the first path segment in opposite directions by a first and a second offset amount respectively, the opposite directions being substantially orthogonal to an orientation of the first path segment; and
selecting if possible, a replacement path for the signal path from the one or more topological equivalent alternate paths.

21. The article of claim 19, wherein said programming instructions are designed to enable the computing apparatus to perform said selecting by
identifying for the first topologically morphed version of the signal path, one or more alternate paths that are topological equivalent to the first topologically morphed version of the signal path; and
selecting if possible, a replacement path for the first topologically morphed version of the signal path from the one or more topological equivalent alternate paths.

22. The article of claim 19, wherein 'said programming instructions are further designed to enable the computing apparatus to generate a second topologically morphed version of the signal path, and selecting if possible, a replacement path for the signal path using the second topologically morphed version of the signal path, when the computing apparatus is unable to select a replacement path for the signal path using the first morphed version of the signal path.

23. An apparatus comprising:
a storage medium having stored therein a plurality of programming instructions designed to implement a signal router, including capabilities to identify for a signal path of a circuit design, one or more alternate paths that are topological equivalent to the signal path, and select if possible, a replacement path for the signal path from the one or more topological equivalent alternate paths; and
at least one processor coupled to the storage medium to execute the programming instructions.

24. The apparatus of claim 23, wherein the programming instructions are further designed to implement the signal router with the capability to perform at least one of said identifying of an alternate path by sliding a path segment of the signal path by an offset amount in a direction substantially orthogonal to an orientation of the path segment.

25. The apparatus of claim 23, wherein the programming instructions are further designed to implement the signal router with the capability to generate a topologically morphed version of the signal path, and select a replacement path for the signal path using the topologically morphed version of the signal path, when the computing device is unable to select a replacement path for the signal path from the one or more topological equivalent alternate paths.

26. An apparatus comprising:
a storage-medium having stored therein a plurality of programming instructions designed to implement a signal router, including capabilities to generate a first topologically morphed version of a signal path of a circuit design, and select if possible, a replacement path for the signal path using the first topologically morphed version of the signal path; and
at least one processor coupled to the storage medium to execute the programming instructions.

27. The apparatus of claim 26, wherein the programming instructions are further designed to implement the signal router with the capabilty to perform said generating by
selecting a first path segment of the signal path;
selecting a point on the first path segment to break the first path segment into a first and a second portion;
sliding the first and second portions of the first path segment in opposite directions by a first and a second offset amount respectively, the opposite directions being substantially orthogonal to an orientation of the first path segment; and
selecting if possible, a replacement path for the signal path from the one or more topological equivalent alternate paths.

28. The apparatus of claim 26, wherein the programming instructions are further designed to implement the signal router with the capability to perform said selecting by
identifying for the first topologically morphed version of the signal path, one or more alternate paths that are topological equivalent to the first topologically morphed version of the signal path; and
selecting if possible, a replacement path for the first topologically morphed version of the signal path from the one or more topological equivalent alternate paths.

29. The apparatus of claim 26, wherein the programming instructions are further designed to implement the signal router with the capability to generate a second topologically morphed version of the signal path, and selecting if possible, a replacement path for the signal path using the second topologically morphed version of the signal path, when the computing apparatus is unable to select a replacement path for the signal path using the first morphed version of the signal path.
